(19) United States
(12) Patent Application Publication
(10) Pub. No.: US 2022/0363957 A1
(43) Pub. Date: Nov. 17, 2022

(54) REPOSITIONABLE ADHESIVE ARTICLES FOR STRETCH RELEASE REMOVAL

(71) Applicant: 3M INNOVATIVE PROPERTIES COMPANY, St. Paul, MN (US)

(72) Inventors: Nishant C. Kumar, St. Paul, MN (US); Payam Khodaparast, Minneapolis, MN (US); Ross E. Behling, Woodbury, MN (US); Kayla C. Niccum, Maplewood, MN (US)

(21) Appl. No.: 17/773,942

(22) PCT Filed: Nov. 3, 2020
(86) PCT No.: PCT/IB2020/060326

§ 371 Date: May 3, 2022

Related U.S. Application Data
(60) Provisional application No. 62/932,969, filed on Nov. 8, 2019.

(51) Int. Cl. C09J 7/38; C09J 7/10; B32B 7/14; B32B 27/32; B32B 27/36; B32B 29/00; B32B 27/16; B32B 29/06

(52) U.S. Cl. CPC C09J 7/385; C09J 7/10; B32B 7/14; B32B 27/32; B32B 27/36; B32B 29/00; B32B 27/16; B32B 29/06; C09J 2203/37; C09J 2301/1242; C09J 2301/302; C09J 2301/308; C09J 2203/366; C09J 2301/204; C09J 2301/21; B32B 2255/10; B32B 2255/26; B32B 2255/28; B32B 2264/1021; B32B 2307/748; B32B 2307/54; B32B 2307/542; B32B 2405/00

(57) ABSTRACT

The present disclosure relates to adhesive article that include a first, stretch releasable adhesive and patterned adhesive elements on, within, or partially embedded in a surface of the adhesive. The adhesive elements can act as spacers between the adhesive surface and the mounting surface to prevent full contact and wet out of the first adhesive, whereby the article can be removed from the wall and placed at a new location without damage to the wall surface or the article. Once the final location is selected, the separation created by the engineered elements can be overcome by applying sufficient pressure; the first adhesive can contact and adhere more permanently to the wall. Thus, a stretch releasable adhesive articles of the present disclosure can move freely relative to the desired mounting surface, while developing additional tack and holding power after sufficient pressure is applied.

### BACKGROUND

The revolutionary Command® Adhesive Strip products are a line of stretch releasable adhesive strips that holds strongly on a variety of surfaces (including paint, wood, and tile) and that remove cleanly—no holes, marks, or sticky residue. In general, these products include a stretch release pressure sensitive adhesive composition disposed on tape or other backings and generally have utility in bonding to various surfaces or substrates for numerous applications. Stretch-release products are designed to firmly adhere an article, such as a hook (to hold a picture or an article of clothing) or other decorative or utilitarian element, to a surface (an adherend), yet remove cleanly when pulled away from the surface at a low angle. The clean removal aspect is so that a tacky and/or unsightly residue is not left behind on the surface after removal of the stretch release adhesive. During the process of stretch release removal, the adhesive layer preferably remains adhered to the tape backing as the backing is stretched, but releases from the surface (adherend).

Stretch releasable adhesives that can be removed from a surface by stretching are known in the patented prior art. U.S. Pat. No. 5,516,581 (Kreckel et al.) discloses a removable adhesive tape having a highly extensible and substantially inelastic backing coated with a layer of pressure sensitive adhesive. U.S. Pat. No. 6,231,962 (Bries et al.) discloses conformable pressure-sensitive adhesive tapes which comprise a layer of polymeric foam in the backing and may be adhered firmly to a substrate and thereafter removed therefrom by stretching at an angle no greater than about 35° from the surface of the substrate. U.S. Pat. No. 7,078,093 (Sheridan et al.) discloses a stretch releasing pressure sensitive adhesive tape including a silicone pressure sensitive adhesive composition that exhibits a 180° peel strength on a glass substrate at 98% relative humidity of at least about 5.47 N/dm, and a non-tacky tab. U.S. Pat. No. 6,395,389 (Lühmann et al.) discloses an adhesive tape strip for a rereleasable adhesive bond, which can be removed from a bonded joint by pulling in the direction of the bond plane, having a non-adhesive grip tab and a subsequent, elongate strip which is adhesive on one or both sides.

### SUMMARY

The inventors of the present disclosure recognized that the existing mounting products suffered from various disadvantages. Existing mounting products seldom allow for a user to adjust location or orientation, even slightly, once the exposed adhesive is placed in contact with the desired mounting surface. The adhesives commonly used in these products, particularly those designed for damage free, stretch release removal, demonstrate high initial tack or “quick stick” behavior, resulting in a rapid setting bond with the wall or other mounting surface

Although several methods and configurations have been developed to make application of mounting articles easier, no solution to date provides for mounting articles capable of forming strong bonds that have a combination of low-stick (re)positioning, rapid bonding when pressed in place and retention of high shear strength allowing for damage free mounting of larger articles.

The inventors of the present disclosure sought to formulate mounting products and/or adhesive articles that combine an ability to initially adjust the position of an adhesive article with an acceptable shear strength suitable for holding large or heavy objects, all while avoiding damage to the mounting surface during initial application, positioning, use, and removal.

In accordance with the present disclosure, an adhesive article is provided which includes a stretch releasable, primary adhesive and a second adhesive layer on, within, or partially embedded in a surface of the primary adhesive. The second adhesive layer can act as a spacer between the primary adhesive surface and the mounting surface to prevent full contact and wet out of the primary adhesive while providing suitable levels of initial adhesion, whereby the article can be removed from the wall after initial placement and placed at a new location. Once the final location is selected, the separation created by the engineered elements can be overcome by applying sufficient pressure; the primary adhesive can contact, wet out, and adhere to the wall. Thus, a stretch releasable adhesive article is provided which can offers initial adhesion based on a secondary adhesive layer, is repositionable, and which develops additional tack after pressure is applied.

The secondary adhesive layer on a primary adhesive provides a unique combination of properties for an adhesive article that may be easily positioned on a substrate surface. Optionally, it may be weakly and temporarily bonded to the substrate and repositioned as desired, then attached to the surface of the substrate with a stronger bond by applying firm pressure. Advantageously, the present disclosure provides an adhesive article that may be removed after application, all the while retaining ease of initial positioning and rapid, more permanent attachment once firm pressure is applied.

In some embodiments, the engineered elements define between about 3% and about 50% percent of a total adhesive article area. In some embodiments, the engineered elements collectively define between about 10% and about 35% percent of a total adhesive article area. In some embodiments, the engineered elements collectively define between about 15% and about 30% of a total adhesive area. In some embodiments, the primary adhesive region (i.e., areas of adhesive which to do not feature engineered elements) comprises between about 60% and about 95% area percent of a total adhesive surface area. In some embodiments, the primary adhesive region comprises between about 20% and about 80% percent of a total adhesive surface area.

In some embodiments, the engineered elements include one or more intrusive features. The intrusive features typically include a plurality of channels in the surface of an adhesive. In some embodiments, the engineered elements include a combination of channels and secondary adhesive elements.

As used herein, “positionable” means an adhesive article that can be placed against a substrate surface and easily slid over the surface into proper position without preadhering or sticking the adhesive article to the substrate; pressure is generally required to adhere the adhesive article to the substrate.

As used herein, “repositionable” means an adhesive article that can be applied to a substrate and then removed and reapplied without distorting, defacing, or destroying the adhesive article, or substrate; repositionable adhesives need not be positionable or vice versa.

As used herein, “repositionable holding” means a repositionable article that can be reapplied to a substrate and will thereafter hold at least 3 pounds according to the Repositionable Holding test.

As used herein, “tack” means the instant contact adhesion between the adhesive and the substrate.

As used herein, an “engineered element”, “engineered feature” and “engineered structure” are used interchangeably mean a structure deliberately applied to or created from an adhesive surface.

As used herein “geometry” refers to the size and shape of an engineered element.

As used herein, the term “pitch” identifies the distance between the centroids of adjacent adhesive or non-adhesive features or regions. The pitch is measured from the centroid of a feature or region (i.e., the geometric center) to the centroid of an adjacent feature or region of like adhesive (or non-adhesive) character.

As used herein, “layer” means a single stratum that may be continuous or discontinuous over a surface.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As recited herein, all numbers should be considered modified by the term “about”.

As used herein, “a”, “an”, “the”, “at least one”, and “one or more” are used interchangeably. Thus, for example, an engineered surface comprising “a” pattern of recesses can be interpreted as an engineered surface comprising “one or more” patterns.

Also, the recitations herein of numerical ranges by endpoints include all numbers subsumed within that range (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF THE DRAWINGS

The disclosure will be further described with reference to the drawings, wherein corresponding reference characters indicate corresponding parts throughout the several views, and wherein:

FIG. 1 illustrates an arrangement of on the surface of an adhesive construction, according to one embodiment of the present disclosure;

FIG. 2 illustrates an arrangement of engineered structures on the surface of an adhesive construction, according to one embodiment of the present disclosure;

FIG. 3A is a segmented planar view of a surface with intrusive channel features according to another embodiment of the present disclosure.

FIG. 3B is a segmented view of an adhesive article highlighting the channel features of FIG. 3A; and

FIG. 4 is a schematic, cross-sectional view of a transfer process used to create an adhesive construction of the present disclosure.

Layers in certain depicted embodiments are for illustrative purposes only and are not intended to absolutely define the thickness, relative or otherwise, or the absolute location of any component. While the above-identified figures set forth several embodiments of the disclosure other embodiments are also contemplated, as noted in the description. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION OF ILLUSTRATIVE EMBODIMENTS

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

Characteristically, the adhesive articles of the present disclosure include a primary adhesive layer and at least one structured surface having topographical adhesive elements in a secondary adhesive layer, such that the article demonstrates at least two levels of adhesion: a contact bond defined by initial tack provided by the secondary adhesive and an application bond provided by the primary adhesive layer. The initial contact bond is substantially less than the application bond and the contact bond can be changed to the application bond with the application of pressure. The engineered adhesive structures thus permit the article to be easily removed from the surface of the substrate, until enough pressure is applied to enable a bond between the adhesive and the surface of the substrate.

The adhesive articles of the present disclosure can be positionable, repositionable, or both. In some advantageous embodiments, the adhesive articles demonstrate repositionable holding, in that the article does not substantially lose shear strength when holding a mounting object on a vertical substrate after the article has been initially adhered, removed, and re-adhered to the substrate

The adhesive articles of the present disclosure can include protrusive engineered structures such as projecting adhesive rails or islands. These elements are at least partially protrusive from the adhesive surface. Protrusive elements represent a departure or deviation away from the average elevation of an otherwise planar surface region.

In some embodiments, the adhesive elements are distributed as a periodic array across a structured surface region (e.g., a one-dimensional array or a two-dimensional array, for example a square array, hexagonal, or other regular array). In some embodiments, the structured surface includes an arranged pattern of features. An “arranged pattern” is a plurality of engineered features arranged at predetermined positions, arranged with some degree of regularity, or arranged in any desired manner. For example, the arranged pattern can include an arranged row pattern, an arranged lattice pattern such as an arranged square lattice pattern, an arranged zigzag pattern, or an arranged radial pattern. The arranged pattern need not be formed evenly on the entire surface but may be formed in only a portion of the article surface. The pattern may vary or remain the same over any portion of the article. For example, similar or different patterns can be used within the same plane. The elements within the pattern can be of similar size and shape or can have different sizes and shapes.

In some embodiments, adhesive elements can be present on a regular repeating basis, on a random basis, or combinations thereof. In other embodiments, the elements can be present over a portion of the entire area of the adhesive region or present over the entire area of the adhesive region. The elements may also in some cases be closely packed, i.e., arranged such that at least portions of boundaries of many or most adjacent elements substantially meet, coincide, of substantially overlap. The structures can be irregularly or non-uniformly dispersed on the adhesive surface.

Advantageously, the creation of adhesive elements according to the methods and concepts herein eliminates or substantially reduces any deleterious effect on the mechanical performance of the base adhesive construction or an article containing the adhesive construction.

The adhesive article embodiments exemplified herein provide excellent adhesion and shear holding power during use as well as damage-free removal from the wall, surface, or substrate to which the adhesive article is adhered, mounted, or attached. The stretch releasable articles herein can include a single or multilayer construction that can be removed from a substrate or surface by stretching it at an angle of less than 35°.

The present disclosure generally relates to adhesive articles that can be removed from a substrate without damage. As used herein, the terms “without damage” and “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

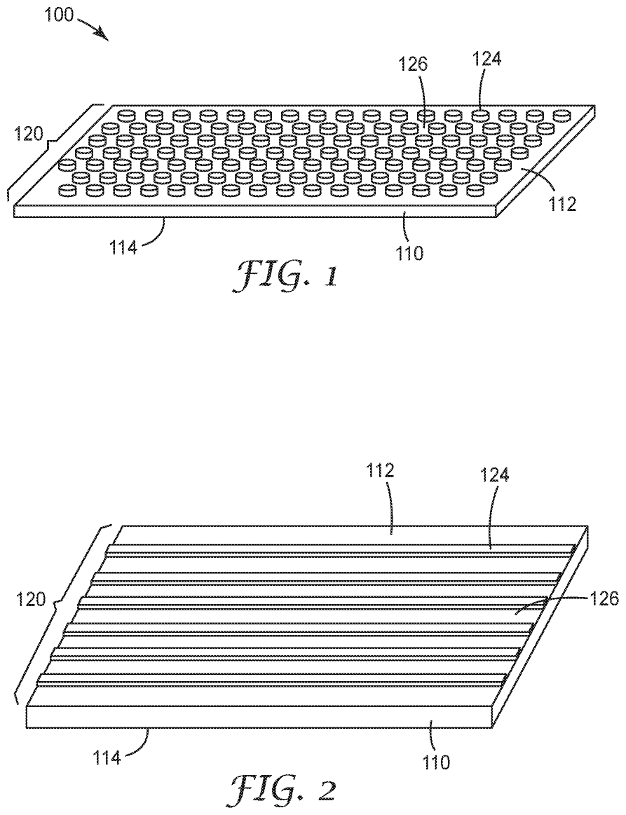

An adhesive article featuring a structured surface of engineered adhesive elements is depicted in FIGS. 1 and 2. Adhesive article 100 includes an adhesive construction 110 including first and second opposed major surfaces 112 and 114. A mounting device (not shown) can be disposed adjacent the second major surface 114 of the adhesive construction 110. The first major surface 112 provides an available adhesive region for securing the article to the desired mounting surface.

The adhesive construction 110 may include a backing or may be backing free. Backing free adhesive constructions are described, for example, in US Publication No. 2016/0068722 (Schmitz-Stapela et al.) and feature a unitary adhesive layer. The adhesive construction 110 may include one or more adhesive layers disposed on a backing. An adhesive layer may be disposed on a backing to provide the primary adhesive surface 112. The second major surface 114 may include or be the result of an additional adhesive layer or may lack significant adhesive functionality. Each adhesive layer may be single layer or multilayer. The backing may likewise be single layer or multilayer. Adhesive layers can be the same as one another or disparate from one another. Disparate, in this context, is used to describe substantial differences in composition or adhesive performance. Adhesive layers can each be continuous or discontinuous (e.g., patterned) across the major surfaces of a backing.

The primary adhesive surface 112 includes a patterned adhesive layer 120 defined by a plurality of adhesive elements 124. The patterned, secondary adhesive layer 120 as depicted includes an arranged pattern of discrete adhesive elements or islands 124. The adhesive elements 124 are arranged in a hexagonal array, but other patterns and arrangements are possible, including unstructured arrays. In some embodiments, the patterns resemble or are a tessellation. In some embodiments, the adhesive elements 124 are distributed as a periodic array across a surface (e.g., a one-dimensional array or a two-dimensional array, for example a square array, hexagonal, or other regular array). For example, the arranged pattern of can include an arranged row pattern, an arranged lattice pattern such as an arranged square lattice pattern, an arranged zigzag pattern, an arranged radial pattern, and combinations thereof. The arranged pattern need not be formed evenly on the entire surface but may be formed in only a portion of the adhesive surface 112. The pattern of adhesive elements may vary or remain the same over any portion of the article. For example, similar or different patterns can be used across the primary adhesive surface 112. The features within the pattern can be of similar geometry or can have different geometries.

In some embodiments, the adhesive elements 124 in the patterned, secondary adhesive layer have an average thickness of between about 1 nm and about 1000 microns. In some embodiments, the adhesive elements have a thickness of between about 1 nm and about 100 microns. In some embodiments, the adhesive elements have a thickness of between about 100 nm and about 50 microns. The adhesive element thickness is typically selected so that the adhesive elements 124 provide sufficient space between the mounting surface and the adhesive layer on initial contact, but do not prevent the adhesive from wetting out and forming a stronger bond on application of adequate pressure. Accordingly, the thickness of the adhesive elements is typically no greater than 4 times the thickness of the adhesive construction.

The adhesive elements 124 can take the form of any shape. The illustrated embodiment of first major surface 112 comprises a plurality of circular islands 124. Other, non-limiting examples of cross-sectional shapes that are suitable for adhesive elements 124 making up the patterned adhesive layer 120 include parallelograms, parallelograms with rounded corners, rectangles, squares, circles, half-circles, ellipses, half-ellipses, triangles, trapezoids, stars, ovals, teardrops, other polygons (e.g., hexagons), etc., and combinations thereof. Each element includes a largest cross-sectional dimension. The size of the largest cross-sectional dimension is not particularly limited but is typically at least 25 microns.

Additional suitable element shapes include irregular geometries that can be described by non-Euclidean mathematics. Non-Euclidean mathematics is generally used to describe those features whose mass is directly proportional to a characteristic dimension of the spaced feature raised to a fractional power (e.g., fractional powers such as 1.34, 2.75, 3.53, or the like). Examples of geometries that can be described by non-Euclidean mathematics include fractals and other irregularly shaped elements. For irregularly shaped features (e.g., features which are not parallelograms, regular polygons, or circles) the largest cross-sectional dimension will be understood to be the diameter of a circle of equivalent area.

In various embodiments, areas of the adhesive surface 112 may include adhesive element 124 patterns of differing sizes, shapes or compositions, and in some embodiments, two or more different configurations of the adhesive elements 124 can be deposited uniformly or randomly on at least a portion of the surface 112. For example, adhesive elements 124 with a first shape or size can be disposed on a first area of the surface 112, and adhesive elements 124 with a second shape or size, different from the first shape or size, can be disposed in a second area of the surface 112.

In various embodiments, the discrete adhesive elements 124 may form a continuous or a discontinuous array over the surfaces 114, or both. For example, some areas of the surface 112 may be free of the adhesive elements 124, while other areas have a dense arrangement of adhesive elements 124. In another example embodiment, various areas of the surfaces 124 may have adhesive elements 124 with varying shapes and feature spacings. The sizes and shapes of the adhesive elements 124 can vary widely, and the adhesive elements 124 need not be the same size or shape in a particular area of the surface 112, or over the entire surface 112. For example, in some embodiments, the adhesive elements 124 can form an aesthetic pattern, an image, a logo, a bar code or a QR code, and the like. In other embodiments, the adhesive elements 124 simply form an array of dots over all or a portion of the surface 112.

A Cartesian x-y-z coordinate system is included in FIGS. 1 and 2 for reference purposes. The first and second major surfaces 112, 114 of the adhesive construction 110 extend generally parallel to the x-y plane, and the thickness of the adhesive construction 110 corresponds to the z-axis. The array of adhesive islands 124 includes a transverse direction, generally along the x-axis and a longitudinal direction, generally along the y-axis. The arranged pattern includes a defined spacing or pitch between nearest-neighboring, adjacent adhesive islands 124. The pitch between adjacent elements 124 in an array or pattern may be the same in both the transverse direction and longitudinal direction. In other embodiments, the pitch along the transverse direction is less than the pitch along the longitudinal direction, and vice versa. In exemplary embodiments, the pitch is between about 80 microns and about 210 microns.

As depicted in FIG. 1, the elements 124 are discrete along both the transverse and longitudinal directions of the first major surface 112. In other embodiments and as demonstrated in FIG. 2, the non-adhesive elements can be discrete along one direction, such that the elements resemble rails or stripes, or may extend diagonally (relative to the orientation shown in e.g., FIG. 1) across the major surface 112 of the adhesive construction. Such rails can follow any desired path and can be continuous or discontinuous across a surface in any given direction.

The patterned adhesive layer 120 includes a plurality of elements 124 each having substantially the same geometry. In other embodiments, the size or shape of the elements 124 may change across the transverse direction, longitudinal direction, or combinations thereof. In yet other embodiments, the patterned adhesive layer 120 can include two or more elements or islands 124 of different geometries arranged in repeating unit cell. The unit cell can be repeated in an arranged pattern of unit cells. A variety of shapes may be used to define the unit cell, including rectangles, circles, half-circles, ellipses, half-ellipses, triangles, trapezoids, and other polygons (e.g., pentagons, hexagons, octagons), etc., and combinations thereof. In such embodiments, each unit cell boundary is directly adjacent the boundary of a neighboring unit cell, so that the plurality of unit cells resembles, e.g., a grid or tessellation.

As discussed above, the adhesive elements 124 are discreet in at least one aspect, resulting in interstitial spaces 126 between any two adjacent elements 124. The interstitial spaces 126 possess adhesive functionality. Accordingly, the sum area of the interstitial spaces 126 defines the primary adhesive region on the first major surface 112. In presently preferred implementations, the elements 124 are not closely packed, such that the boundaries of any individual elements 124 are not directly adjacent, coincident, or overlapping the boundaries of any adjacent adhesive elements 124. This provides sufficient interstitial space to realize the damage reduction, repositionability, shear strength, and other benefits extolled below.

For any of the arranged distributions of adhesive elements described herein, the area of the adhesive surface including the plurality of non-adhesive elements is typically smaller than the area bound within interstitial spaces 126. In some embodiments, no greater than 50% of the area of is contained within the patterned adhesive layer, in some embodiments no greater than 40% of the area, in some embodiments no greater than 30%, in some embodiments no greater than 20%, in some embodiments no greater than 15%, and in yet additional embodiments no greater than 10% of the area is defined by the patterned adhesive layer 120. In certain circumstances, a patterned adhesive layer exceeding 40% of the total area may detract from the shear strength of the adhesive article or interfere with establishing an application bond. For light weight hanging implementations, however, such reduced shear strength may nonetheless be suitable. If repositionability or repositionable holding behavior is desired, it can be useful, in some circumstances, to maintain the surface area defined by the patterned adhesive layer to at least 3% and no greater than 35% of the total area, and in some embodiments no greater than 30%. Typically, about 10% to about 30% of the total area of is contained within the patterned adhesive layer

The arranged pattern may result in a particular density of adhesive elements 124 per square inch (i.e., dots per inch square or DPI). In some implementations, the first surface 112 comprises no greater than 150,000 elements per square inch, in some embodiments no greater than 100,000, in some embodiments no greater than 75,000, in some embodiments no greater than 35,000, in some embodiments no greater than 25,000, in some embodiments no greater than 15,000, in some embodiments no greater than 7500, in some embodiments no greater than 6500, in some embodiments no greater than 5000, and, in other embodiments no greater than 4000 elements per square inch. Without wishing to be bound by theory, greater density of the adhesive elements is correlated with compromised shear performance of the adhesive article but can aid in both positionability and repositionability (depending on at least non-adhesive surface area).

Any of the prior embodiments of a patterned, secondary adhesive layer described above may be combined with intrusive features. Intrusive features (e.g., recessed features) can generally be described as features having surface points that lie below an average elevation of the adhesive surface. Recessed features, for example, can be referred to as recesses, wells, cavities, concavities, pockets, channels, and the like. Recessed features can have a volume with dimensions such as diameter, radius, depth, length, and width. A base of the recessed feature can generally refer to a location within the recessed feature having points lying closest to an average elevation, while the surface or region of the recess farthest from the average elevation is considered an apex.

In particular embodiments, the intrusive features define channels in the relevant adhesive layer. The channels may be utilized to create exit pathways for fluid (e.g., liquid, air, or other gases) egress to a periphery of the article when the article is applied to a desired adherend Channels are continuous open pathways or grooves that extend into the adhesive from the exposed surface. The channels typically either terminate at the peripheral portion of the adhesive layer or communicate with other channels that terminate at a peripheral portion of the article. Upon application of the article onto a substrate, the pathways provide an egress to a periphery of the article for fluid (particularly air) trapped at the interface between the adhesive and the substrate.

The channels are typically created to define a specific volume per any given area of the surface of the adhesive. The minimum volume per unit area of the adhesive ensures adequate egress for fluids at the interface of the intended adherend and the adhesive. Typically, the channels define a volume of at least 1*10³ μm³ per any 500 μm diameter circular area in a two-dimensional plane of the adhesive layer.

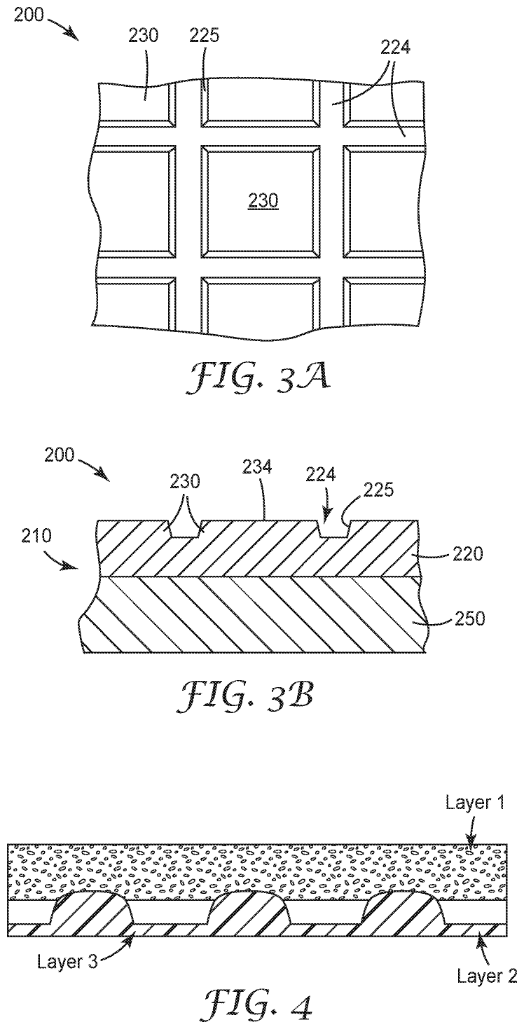

The shape of the channels can vary according to the processing methods, but each typically has a V-shaped, U-shaped, rectangular or trapezoidal cross section on observation in a transverse direction. FIGS. 3A and 3B shows a segmented view of a stretch releasable article 200 highlighting trapezoidal channels 224 in an adhesive construction 210. The adhesive construction 210 includes a backing 250 and an adhesive 220, though adhesive only constructions are also possible. The trapezoidal channels 224 and corresponding land structures 230 defined by the channels are formed in the adhesive 220. Side walls 225 of the channels 224 define side walls for the land structures 230.

Though not depicted, the exposed major surface 234 of the land structures will include a distribution of protrusive adhesive elements of the types described herein. In certain embodiments, the channels are substantially free of protrusive engineered features, though this is not strictly necessary.

The limits of dimensions of the channels can be described by use of the aspect ratio. The aspect ratio is defined as the ratio of the greatest microscopic dimension of the channel parallel to the plane of the continuous layer of adhesive to the greatest microscopic dimension of the channel perpendicular to the plane of the continuous layer of adhesive. The aspect ratio is measured by taking the cross-sectional dimensions of the channel at an angle perpendicular to the wall of the channel Depending on the specific type of channel, the limits of the aspect ratio would be about 0.1 to about 20. For example, the structures of FIGS. 3A and 3B would define channels that would have a presently preferred aspect ratio of about 10 to about 15.

Channels are generally created by embossing or forming a plurality of structures into the adhesive. The structures may be present in either a random array or in regular patterns. Individual structures at least partially define a portion of a channel in the adhesive. Selected patterns could include rectilinear patterns, polar patterns and other conventional regular patterns. A plurality of structures combines to create the continuous channels on the surface of the adhesive.

The shape of the land structures formed in the adhesive can vary. Examples of land structure shapes include but are not limited to those selected from the group consisting of hemispheres, prisms (such as square prisms, rectangular prisms, cylindrical prisms and other similar polygonal features), pyramids, or ellipsoids. Combinations of the different structure shapes can be utilized. Each individual structure typically has a height, as measured from the apex of the defining channels, of greater than about 3 micrometers but less than the total thickness of the adhesive layer, and preferably about 3 micrometers to about 50 micrometers. Additionally, some of the land structures may be truncated to provide a surface for additional engineered elements, to control the contact surface of the adhesives, and to improve the wet out of the adhesive. The land structures can be arranged at a pitch of about 400 μm or less, and in some embodiments about 300 μm or less.

The structured adhesive surface including intrusive features has a total are “T”, a first area “A” for land structures, and an area “B” for channels. The percentage of “A” to “T” can range from about 35% to about 99%. In other embodiments, the percentage can range from about 50% to about 98%, about 60% to about 97%, about 70% to about 96%, and about 85% to about 95%. The latter range can typically provide adequate fluid egress without substantially compromising adhesion to typically desired adherends. The percentage of “B” to “T” is accordingly the remaining percentage in the each of the above.

The intrusive features can be made by imparting a topographical surface onto an adhesive with practices conventionally recognized in the art. The features are imparted by embossing the adhesive directly through utilization of molding tools or by coating the adhesive onto a liner or backing previously embossed with an inverse pattern of features. Such methods and practices are exemplified in U.S. Pat. No. 5,650,215 (Mazurek et al.) and U.S. Pat. No. 9,085,121 (Mikami et al.), each of which is incorporated in its entirety herein. Intrusive features may be created contemporaneously with the protrusive features or may be imparted to the adhesive surface before or after the creation of the protrusive, engineered features.

The use of engineered adhesive elements (with or without intrusive elements) can provide a measure of repositionability to stretch release adhesive articles of the present disclosure. That is, the article can be placed on a surface with a contact bond, removed, and reapplied to the same or different location at least once. The article can then be subjected to pressure sufficient to form a viable application bond. In presently preferred embodiments, the combination of primary and secondary adhesive layers provides a suitable degree of repositionability without unduly sacrificing shear strength and wet out. In particularly advantageous embodiments, the adhesive article can withstand a mounting weight (i.e., load) of at least 6 lbs without damaging in the substrate according to the Repositionability test below. In yet more advantageous embodiments, the adhesive articles of at least 8 lbs, or at least 10 lbs without damaging in the substrate according the Repositionability test below. Without wishing to be bound by theory, the higher mounting weight before damage equates to a user's potential or likely applied force when selecting an initial position for the adhesive article; the user may be conditioned to press hard or may have little intuitive feel for “light” pressure, and the ability to maintain repositionability despite higher application forces could be advantageous for certain mounting applications.

Adhesive Articles

Adhesive articles of the present disclosure typically have excellent shear strength. Some embodiments of the present disclosure have a shear strength of greater than 1600 minutes as measured according to ASTM D3654-06 (2011). Some embodiments of the present disclosure have shear strength of greater than 10,000 minutes as measured according to ASTM D3654-06 (2011). Some other embodiments of the present disclosure have shear strength of greater than 100,000 minutes as measured according to ASTM D3654-06 (2011).

In presently preferred implementations of the present disclosure, the adhesive article combines excellent shear strength with Repositionability, as outlined in the Examples below.

Some adhesive articles of the present disclosure demonstrate improved weight bearing capacity on application bond, holding a 3, 6, or 9 lbs weight for at least 15 days according to the Package Weight Claim test. In presently preferred embodiments, the adhesive articles of the present disclosure demonstrate improved weight bearing capacity on application bond, holding a 3, 6, or 9 lbs weight for at least 30 days according to the Package Weight Claim test.

Some adhesive articles may demonstrate weight bearing capacity with an initial contact bond between the secondary adhesive layer and the substrate. In presently preferred embodiments, the adhesive articles of the present disclosure demonstrate improved weight bearing capacity, holding a 1 or 3 lbs weight for at least 30 days according to the Package Weight Claim test.

In some embodiments, the adhesive article has an elongation at break of at least 400%. Some adhesive articles of the present disclosure have an elongation at break of between about 400% and about 1500% in at least one direction. In some embodiments, the stretch releasable article can be stretched at least 100 percent, at least 150 percent, at least 200 percent, at least 300 percent, at least 400 percent, or at least 500 percent without breaking. The stretch releasable layer and/or film can often be stretched up to 1500 percent, up to 1200 percent, up to 1000 percent, up to 800 percent, up to 750 percent, or up to 700 percent without breaking. These relatively large elongation values facilitate stretch releasing of the adhesive articles of the present disclosure after being adhered to a substrate. Some adhesive articles of the present disclosure have a tensile strength at break sufficiently high so that the adhesive article will not rupture prior to being stretched and removed from an adherend at an angle of 35° or less.

In some embodiments, the adhesive article exhibits an elastic recovery of greater than 70% or greater than 80% or greater than 95% at 10% strain. In some embodiments, the adhesive article exhibits an elastic recovery of greater than 70% or greater than 80% or greater than 90% at 25% strain. In some embodiments, the adhesive article exhibits an elastic recovery of greater than 70% or greater than 80% or greater than 90% or greater than 95% at 50% strain. In some embodiments, the adhesive article exhibits an elastic recovery of greater than 50% or greater than 70% or greater than 95% at 100% strain.

In some embodiments that use a backing in the adhesive construction, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments have a haze of no greater than 20%. Some embodiments have a haze of no greater than 20%. Both the light transmission and the haze of the carrier (or at least some of the layers thereof) can be determined using, for example, ASTM D1003-00.

In some embodiments, the adhesive article further includes a tab. The tab is an area that can be easily accessed by the user to assist in or begin to stretch release the adhesive article from the adherend. The removal tab can be tacky from the outermost adhesive layer or non-tacky by being covered by layers of stretch film, non-stretch film, release liner, or from detackified adhesive.

In some embodiments, the adhesive article further includes one or more release liners. The release liner can be, for example, on either or both of the major surfaces of the stretch releasable adhesive layers. The release liner protects the adhesive during manufacturing, transit, and before use. When the user desires to use the adhesive article, the user can peel or remove the release liner to expose the adhesive. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. No. 4,472,480 (Olson), 4,980,443 (Kendziorski et al.) and 4,736,048 (Brown et al.), and incorporated herein. Preferred release liners are fluoroalkyl silicone polycoated paper. The release liners can be printed with lines, brand indicia, or other information.

In some embodiments, the adhesive article has a thickness that is between about 2 mil and about 40 mils. In some embodiments, the thickness is greater than 3 mil, greater than 4 mil, greater than 5 mils, greater than 8 mils, greater than 10 mils, greater than 12 mils, greater than 15 mils, or greater than 20 mils. In some embodiments, the thickness is less than 40 mils, less than 38 mils, less than 35 mils, less than 33 mils, less than 30 mils, less than 28 mils, less than 25 mils, less than 22 mils, or less than 20 mils.

In some embodiments, a force of between about 1N and about 50N per inch width is required to strain the adhesive article 10% in tensile elongation as measured according to ASTM D638-14 and/or ASTM D412-06a. In some embodiments, a force of between about 2N and about 30N per inch width is required to strain the adhesive article 10% in tensile elongation as measured according to ASTM D638-14 and/or ASTM D412-06a. In some embodiments, a force of between about 3N and about 15N per inch width is required to strain the adhesive article 10% in tensile elongation as measured according to ASTM D638-14 and/or ASTM D412-06a.

In some embodiments, the adhesive article has an elongation at break of at least 400%. Some adhesive articles of the present disclosure have an elongation at break of between about 400% and about 1500% in at least one direction. In some embodiments, the stretch releasable article can be stretched at least 100 percent, at least 150 percent, at least 200 percent, at least 300 percent, at least 400 percent, or at least 500 percent without breaking. The stretch releasable layer and/or film can often be stretched up to 1500 percent, up to 1200 percent, up to 1000 percent, up to 800 percent, up to 750 percent, or up to 700 percent without breaking. These relatively large elongation values facilitate stretch releasing of the adhesive articles of the present disclosure after being adhered to a substrate.

In some embodiments, the adhesive article can further include a separable connector. Some exemplary separable connectors are described in, for example, U.S. Pat. Nos. 6,572,945 and 7,781,056 (Bries et al.)

Constituent elements of the adhesive articles described herein are explored in more detail below.

Backing

If used, the backing can be a single layer or a multilayer construction. More than one backing layer can be present in the backing. Multiple backing layers can be separated by layers of film, which may further contain one or more layers. In some embodiments, the backing includes at least one of plastic, metal, paper, nonwoven material, textile, woven material, foam, adhesive, gel, and/or a filament reinforced material. In some embodiments, the backing is at least one of a single layer of material or a multilayer film. In other embodiments, the backing can be an arrangement of particles disposed between adjacent adhesive layers.

In some embodiments, two or more sub-layers can be co-extruded so as to form the backing. In some embodiments, the backing is flexible. Some embodiments include dyes or pigments in the backing layer. Some embodiments include at least one tackifier in at least one layer of the backing. Some embodiments include a plasticizing oil in one or more layers of the backing.

The backing can be any desired shape including, for example, square, rectangle, triangular, polygon, circular, quadrilateral, trapezoidal, cylindrical, half-circular, star-shaped, half-moon shaped, tetrahedral, etc.

The backing can be made of any desired material or materials. Representative examples of materials suitable for the backing can include, for example, polyolefins, such as polyethylene, including high density polyethylene, low density polyethylene, linear low density polyethylene, and linear ultralow density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadienestyrene copolymers, and ethylene/propylene copolymers; acrylic polymers and copolymers; polyurethanes; and combinations of the foregoing. Mixtures or blends of any plastic or plastic and elastomeric materials such as polypropylene/polyethylene, polyurethane/polyolefin, polyurethane/polycarbonate, polyurethane/polyester, can also be used.

In some embodiments, the backing is or includes a composite foam that includes a flexible polymeric foam layer, a first film laminated to a first major surface of the foam layer, and a second film laminated to a second, opposite major surface of the foam layer. Adhesive(s) can be attached to the films to form a structure of adhesive-film-foam-film-adhesive. The flexible polymeric foam layer can be chosen to optimize conformability and resiliency properties which are helpful when an adhesive article is to be adhered to surfaces having surface irregularities. Such is the case with a typical wall surface. An exemplary flexible polymeric foam layer is commercially available under the trade designation “Command” from 3M Company of St. Paul, Minn. In some embodiments, the flexible polymeric foam layer of the backing can include polyolefin foams which are available under the trade designations “Volextra” and “Volara” from Voltek, Division of Sekisui America Corporation, Lawrence, Mass. In some embodiments, the backing is or includes a metal or is metal-like. In some embodiments, the backing is or includes wood or is wood-like.

The backing can be or include one of the materials or backings described in any of the following patent applications, all of which are incorporated in their entirety herein: International Publication Nos. WO2015/195344 (Runge et al.), 2018/144331 (Runge et al.), WO2018/183195 (Lehmann et al.), WO2019/005831 (Hoffman et al.) and WO2019/040820 (Krull et al.), all assigned to the present assignee.

In some embodiments, the backing material has a storage modulus of between about 15×10³ Pa and about 2.5×10⁶ Pa at 25 degrees Celsius. In other embodiments including those with glass materials or other ceramics, the backing material can have a storage modulus of up 1×10¹⁰ Pa. In some embodiments, the backing material has a tan δ (where tan δ is the loss modulus divided by the storage modulus) of between about 0.4 and about 1.2 at 25 degrees Celsius. In some embodiments, the backing has a glass transition temperature of between about −125 and about 40 degrees Celsius. In other embodiments, the backing material has a stress relaxation between 10% and 100% after 10 seconds.

In some embodiments, the backing exhibits an elastic recovery of 1-99% at 10% strain. In some embodiments, the backing exhibits an elastic recovery of 1-99% at 20% strain. In some embodiment of the disclosure, the backing material has an elongation at break of greater than 50% in at least one direction. In some embodiment of the disclosure, the backing material has an elongation at break of between about 50% and about 1200% in at least one direction.

In some embodiments, the backing has a Young's modulus of between about 100 psi and about 100,000 psi. In other embodiments featuring glass materials or ceramics, the backing may have a Young's modulus of up to 10,000,000 psi. In some embodiments, the backing exhibits an elastic recovery of 1-100% at 10% strain as measured by ASTM D5459-95. In some embodiments, the backing exhibits an elastic recovery of 1-100% at 20% strain.

In some embodiments, the backing has a modulus of elasticity and/or a modulus of secant of between about 100 psi and about 15,000 psi as determined by at least one of ASTM D638-14 and ASTM D412-06a. In some embodiments, the backing has a modulus ranging between 100 psi and 15000 psi. In some embodiments the modulus is greater than 100 psi, greater than 500 psi, greater than 1000 psi. In some embodiments the backing modulus is less than 15000 psi, less than 10000 psi, less than 8,000 psi, less than 5,000 psi, less than 3,500 psi, less than 2000 psi, and less than 1500 psi.

In some embodiments, the backing has a thickness of between about 0.1 mils and about 100 mils. In some embodiments, the backing has a thickness of greater than 1 mil, greater than 5 mils, greater than 8 mils, greater than 10 mils, greater than 12 mils, greater than 15 mils, greater than 20 mils, greater than 22 mils, or greater than 24 mils. In some embodiments, the backing has a thickness of less than 100 mils, less than 90 mils, less than 80 mils, less than 75 mils, less than 70 mils, less than 65 mils, less than 60 mils, less than 55 mils, less than 50 mils, less than 45 mils, less than 40 mils, less than 38 mils, less than 35 mils, less than 32 mils, less than 30 mils, less than 28 mils, or less than 25 mils.

Adhesive

The adhesives used in the first (primary) and patterned (secondary) layers described herein can include any adhesive having the desired properties. The primary and secondary adhesive layers 112, 120 can be the same as one another or different from one another. Either or both of the primary or secondary adhesive layers 112, 120 may include a single adhesive composition or multiple adhesive compositions.

The secondary adhesive(s) typically have a reduction in adhesive properties (peel adhesion or tack) as compared to the primary adhesive(s) ranging from about 1% to about 60% as measured by ASTM D3330/3330M-04 (for peel adhesion) and/or ASTM D2979-01 (2009) (probe tack). In presently preferred implementations, the secondary adhesive layer has a reduction in adhesive properties (peel adhesion or tack) as compared to the primary adhesive layer ranging from about 5% to about 50%.

In some embodiments, the one or more secondary adhesives have a reduction in adhesive properties (peel adhesion or tack) as compared to the primary adhesive(s) of at least about 10% as measured by ASTM D3330/3330M-04 (for peel adhesion) or ASTM D2979-01 (2009) (probe tack). In some embodiments, the one or more secondary adhesives have a reduction in adhesive properties (peel adhesion or tack) as compared to the primary adhesive of at least about 15% as measured by ASTM D3330/3330M-04 (for peel adhesion) or ASTM D2979-01 (2009) (probe tack). In some embodiments, the one or more secondary adhesives have a reduction in adhesive properties (peel adhesion or tack) as compared to the primary adhesive of at least about 20% as measured by ASTM D3330/3330M-04 (for peel adhesion) or ASTM D2979-01 (2009) (probe tack). In some embodiments, the one or more secondary adhesives have a reduction in adhesive properties (peel adhesion or tack) as compared to the primary adhesive(s) of at least about 30% as measured by ASTM D3330/3330M-04 (for peel adhesion) or ASTM D2979-01 (2009) (probe tack). In some embodiments, the one or more secondary adhesives have a reduction in adhesive properties (peel adhesion or tack) as compared to the primary adhesive(s) of at least about 40% as measured by ASTM D3330/3330M-04 (for peel adhesion) or ASTM D2979-01 (2009) (probe tack). In some embodiments, the one or more secondary adhesives have a reduction in adhesive properties (peel adhesion or tack) as compared to the primary adhesive(s) of at least about 50% as measured by ASTM D3330/3330M-04 (for peel adhesion) or ASTM D2979-01 (2009) (probe tack).

Primary Adhesive Layer

In some embodiments, the adhesive used in the first adhesive layer is stretch releasable. As used herein, the term “stretch-releasable” means removable from the surface of an adherend by stretching in the direction of the bond plane to an elongation of greater than 50%. In some embodiments, the adhesive releases cleanly from the surface of an adherend when the adhesive article is stretched at an angle of about 35° or less from a surface of the adherend. In some embodiments, the stretch releasable adhesive releases from a surface of an adherend when the multilayer carrier is stretched at an angle of about 35° or less from the adherend surface such that there are substantially no traces of the adhesive left behind on the surface of the adherend.

In some embodiments, the stretch releasable adhesive used in the primary adhesive layer is a pressure sensitive adhesive. A general description of useful pressure sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Pressure sensitive adhesive compositions are well known to those of ordinary skill in the art to possess properties including the following: (1) tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Suitable PSAs may be based on crosslinked or non-crosslinked (meth)acrylics, rubbers, thermoplastic elastomers, silicones, polyurethanes, and the like, and may include tackifiers in order to provide the desired tac, as well as other additives. In some embodiments, the PSA is based on a (meth)acrylic PSA or at least one poly(meth)acrylate, where (meth)acrylate refers to both acrylate and methacrylate groups. In some embodiments, the PSA is an olefin block copolymer based adhesive. Acrylic based pressure sensitive adhesives are described in U.S. Pat. No. 4,726,982 (Traynor et al.) and in U.S. Pat. No. 5,965,256 (Barrera), for example. Silicone based pressure sensitive adhesives are described in U.S. Pat. No. 6,730,397 (Melancon et al.) and U.S. Pat. No. 5,082,706 (Tangney), for example. Polyurethane based pressure sensitive adhesives are described in U.S. Pat. Appl. Pub. No. 2005/0137375 (Hansen et al.), for example. Olefin block copolymer based pressure sensitive adhesives are described in U.S. Pat. Appl. Pub. No. 2014/0335299 (Wang et al.), for example.

Some exemplary stretch releasable adhesives that can be used in the adhesive articles described herein include, for example, those described in U.S. Pat. No. 6,569,521 (Sheridan et al.) or International Publications WO/2017/136188 (Runge et al.), WO/2017/136219 (Antony et al.), or US Publication No. 2016/0068722 (Schmitz-Stapela et al.). In some embodiments, the adhesive layer includes one or more hydrocarbon block copolymers; and a polar phenolic tackifier comprising a phenolic moiety and having a hydroxyl value of between 20 to 130 and an acid value of less than 0.5. In some embodiments, the adhesive includes at least one of the polar phenolic tackifiers is a terpene phenol.

Some stretch releasable adhesives that can be used in the adhesive articles of the present disclosure have a glass transition temperature of about −125° C. to 20° C., as determined by dynamic mechanical analysis of the tan δ peak value. Some stretch releasable adhesives that can be used in the adhesive articles of the present disclosure have a storage modulus of about 400,000 Pa or less, or 300,000 or less at 25° C., as determined by dynamic mechanical analysis.

In some embodiments, the thickness of the stretch releasable adhesive on at least one of the first or second major surfaces of the multilayer carrier is about 1 μm to about 1 mm.

In some embodiments, the stretch releasable adhesives are tailored to achieve removal with no or minimal damage. Exemplary methods and articles for doing so are described in, for example, U.S. Pat. No. 6,835,452 (Hamerski) and International Publication No. WO/2018/039584 (Runge et al.), each incorporated herein in its entirety.

Secondary Adhesive Layer

The adhesive used in the secondary, patterned adhesive layer can be a pressure sensitive adhesive and/or stretch releasable adhesive as described above. In presently preferred implementations of the present disclosure, the adhesive used in the patterned adhesive layer includes one or more hydrocarbon block copolymers; a polar phenolic tackifier; and one or more inorganic particle fillers. The inorganic particles included in the secondary adhesive composition tend to enhance the performance of the resulting adhesive. More particularly, the inorganic particles tend to increase the cohesive strength of the pressure-sensitive adhesive and tend to increase the rubbery plateau modulus.

The inorganic particles can be uniformly or non-uniformly distributed throughout the pressure-sensitive adhesive composition. The inorganic particles can be any suitable metal, metal alloy, metal oxide, ceramic material, or mixture thereof. The inorganic particles are often selected from, but not limited to, alumina, titania, zirconia, silica, or the like. In many embodiments, the inorganic particles are fumed silica particles. Suitable fumed silica is commercially available, for example, under the trade designation AEROSIL (e.g., AEROSIL R972, R974, R976, R300, R380, R130, R150, R200, R202, R805, and R812) from Evonik Industries (Essen, Germany) or under the trade designation CABOSIL (e.g., CABOSIL TS-720, TS-610, TS-530, and TS-500) from Cabot (Alpharetta, Ga.). The fumed silica can have any suitable surface area. For example, the surface area can be in the range of 1 to 500 m²/gram, in the range of 10 to 400 m²/gram, or in the range of 100 to 400 m²/gram. The fumed silica can have any suitable particle size. In some applications, the fumed silica has an average primary particle size less than 30 microns, less than 15 microns, less than 10 microns, less than 5 microns, and less than 1 micron. While nanoscale fumed silica may be used in certain implementations, the use of fumed silica having an average primary particle size less than 200 nanometers may result in substrate damage. Although either hydrophobic or hydrophilic fumed silica can be used, hydrophobic fumed silica is often used because such particles tend to disperse better in the organic solvents typically included in the various compositions.

In other embodiments, the inorganic particles are aerogels such as silica aerogel particles (e.g., crushed aerogels or aerogel powder). The silica aerogel particles often have pores in the nanometer range (e.g., less than 100 nanometers or less than 50 nanometers) and have surface areas equal to at least 500 m²/gram. Exemplary aerogel silica particles can have an average particle size that is less than 20 microns or less than 10 microns. Although the size of the silica aerogel particles is larger than the wavelength of light, the particles are often translucent and can be used to form adhesive layers that are relatively clear even though they may not be considered to be optically clear. Exemplary silica aerogel particles in translucent and opacified grades are commercially available under the trade designation NANOGEL from Cabot (Billerica, Mass.).

Although the inorganic particles can be surface modified to facilitate dispersion in the silicone polymer or the adhesive composition, the inorganic particles are often not surface modified. The inorganic particles can be agglomerated or non-agglomerated and aggregated or non-aggregated. The inorganic particles can have any desired particle size or particle shape. If an optically clear adhesive article is desired, the inorganic particles are often selected to have an average particle size that is less than 1000 nanometers. For example, the average particle size is often less than 500 nanometers, less than 200 nanometers, less than 100 nanometers, or less than 50 nanometers. To prepare adhesive articles that do not need to be optically clear, larger inorganic particles can be used. For example, the inorganic particles can have an average particle size up to 5 micrometers, up to 10 micrometers, up to 20 micrometers, up to 50 micrometers, or up to 100 micrometers.

Typically, the inorganic particles will be added to a level of about 0.1% to about 30% by weight (i.e., wt-%) based upon the total weight of the adhesive composition, or any amount within that range. In presently preferred implementations the inorganic particles are added to a level of about 2% to about 25% by weight, about 5% to about 20%, and about 10% to about 20% by weight based upon the total weight of the adhesive composition, and any amounts within those specified ranges. Filler loadings below 30% by weight, particular those in the presently preferred ranges, can encourage adhesive compositions to demonstrate at least one of damage free removal, repositionability, and high shear strength, even in wet or humid environments (as demonstrated by at least the results of the Examples below).

In various embodiments, the primary adhesive layer may also include inorganic particle filler. Both the primary and secondary adhesive compositions can further include other additives to provide desired properties. For example, dyes and pigments can be added as colorant; electrically and/or thermally conductive compounds can be added to make the adhesive electrically and/or thermally conductive or antistatic; antioxidants and antimicrobial agents can be added; and ultraviolet light stabilizers and absorbers, such as hindered amine light stabilizers (HALS), can be added to stabilize the adhesive against ultraviolet degradation and to block certain ultraviolet wavelengths from passing through the article. Other additives include, but are not limited to, adhesion promoters, additional fillers (e.g., carbon fibers, carbon black, glass beads, glass and ceramic bubbles, glass fibers, mineral fibers, clay particles, organic fibers such as nylon, metal particles, or unexpanded polymeric microspheres), tack enhancers, blowing agents, hydrocarbon plasticizers, and flame-retardants.

Hardgoods

Some embodiments further include a hardgood or mounting device. Exemplary hardgoods or mounting devices include, for example, hooks, knobs, clips, and loops. In some embodiments, the hardgood resembles a nail. In some embodiments, the hardgood has a single outward projection to act as a hanging surface. In some embodiments, the hardgood has multiple outward projections to act as a hanging surface. In some embodiments, the hardgood has is molded into a shape that can hold one or more items within such as but not limited to a box or caddy. In some embodiments, the hardgood is a shelf, ledge, or rack. In some embodiments, the hardgood is a bar wherein the bar can be straight or curved or substantially a ring wherein the bar can be mounted parallel or normal to the substrate surface. In some embodiments, the hardgood uses multiple methods for mounting or hanging items. Any of the following mounting devices can be used with the adhesive article of the present disclosure: Application Matter No. 77486US002 (assigned to the present assignee), U.S. Pat. No. 5,409,189 (Luhmann), U.S. Pat. No. 5,989,708 (Kreckel), 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.), all of which are incorporated by reference in their entirety herein. The hardgood may be any object to be mounted to a substrate.

In some embodiments, the hardgood is mounted to the substrate in one or more places wherein one or more of the mounting locations contain an adhesive article described in this invention. In some embodiments, the hardgood is mounted using a combination of removable article(s) and conventional mechanical fasteners including but not limited to nails, screws, bolts, and rivets.

In some embodiments, the hardgood is made from of thermoplastic polymers. In some embodiments, the hardgood is made from thermoset polymers. In some embodiments, the hardgood is made using polyolefin materials. In some embodiments, the hardgood is made using polycarbonate materials. In some embodiments, the hardgood is made using high-impact polystyrene. In some embodiments, the hardgood is made using acrylonitrile-butadiene-styrene (ABS) terpolymers. In some embodiments, the hardgood is made using two or more polymeric materials. In some embodiments, the hardgood is made from metal. In some embodiments, the hardgood is made from stainless steel. In some embodiments, the metal is painted, glazed, stained, brushed, or coated to alter its appearance. In some embodiments the hardgood is made from ceramic. In some embodiments, the hardgood is made from glazed ceramic. In some embodiments, the hardgood is made from unglazed ceramic. In some embodiments, the hardgood is comprised of naturally-based materials such as wood, bamboo, particle board, cloth, canvas, or derived from biological sources, and the like. In some embodiments, the naturally-based materials may be painted, glazed, stained, or coated to change their appearance. In some embodiments, the hardgood is made using two or more materials from the list above. In some embodiments, the hardgood is made from two pieces that are reversibly or irreversibly attached, joined, or welded together.

In some embodiments, the hardgood comprises two pieces wherein the first piece acts as a mounting surface for attaching the adhesive article to a substrate, and the second piece acts as a hanging member which may be used for hanging or mounting objects to the substrate. The two pieces may be reversibly attached using mechanical fasteners, hook and loop materials, or an additional adhesive layer.

The hardgood can be made using any method known in the art. In some embodiments, a backing and/or the stretch releasable adhesive layer(s) may be attached manually by the end user.

Methods of Making

The adhesive articles and mounting assemblies described herein can be made in various ways. Adhesive mounting assembly can be formed as a single component construction whereby, for example, the adhesive mounting assembly is cast or molded using a single material or multiple materials. Alternatively, adhesive mounting assembly can be formed as a two-component construction whereby a separately formed mounting device is adhered or attached to a separately formed backing during, for example, manufacturing or consumer use.

The primary adhesive can be prepared using a variety of common methods for preparing adhesives. For example, the adhesive composition can be coated onto a release liner, coated directly onto a backing, or formed as a separate layer (e.g., coated onto a release liner) and then laminated to a backing. In some embodiments, the primary adhesive can be formed simultaneously with the backing. For example, a multilayer film consisting of at least two layers, at least one of which is an adhesive, can be coextruded. In some embodiments, the construction can be formed in a cast or blown film construction.

To improve adhesion of the adhesive composition to the backing, the backing can be pretreated prior to applying, e.g., coating or laminating, the adhesive composition on the backing. Examples of suitable treatments include corona discharge, plasma discharge, flame treatment, electron beam irradiation, ultraviolet (UV) radiation, acid etching, chemical priming and combinations thereof. The treatment can optionally be performed with a reactive chemical adhesion promoter including, e.g., hydroxyethylacrylate, or hydroxyethyl methacrylate, or another reactive species of low molecular weight.

The secondary adhesive layer may be applied to a surface of the primary adhesive layer according to any available method. In certain embodiments, the secondary adhesive can be deposited onto a release liner and transferred to the primary adhesive layer. In certain embodiments, the release liner is provided to cover and protect the external surface of adhesive, where the secondary adhesive is at least partially embedded therein such that when the release liner is peeled from the adhesive, the secondary adhesive remains with the primary adhesive. Peeling the release liner from the adhesive layer can simultaneously create selected areas having modified adhesive functionality.

Intrusive features, and combinations of intrusive and protrusive features, may be created according to at least the methods outlined in U.S. Pat. No. 6,197,397 (Sher et al.).

Methods of Using the Adhesive Articles Described Herein

The adhesive articles of the present disclosure can be used in various ways. In some embodiments, the adhesive article is applied, attached to, or pressed into an adherend. In this way, the adhesive article contacts the adherend. Where a release liner is present, the release liner is removed before the adhesive article is applied, attached to, or pressed into an adherend. In some embodiments, at least a portion of the adherend is wiped with alcohol before the adhesive article is applied, attached to, or pressed into an adherend.

The secondary adhesive layer may be used to form an initial contact bond with the adherend. In various implementations, the contact bond may have sufficient shear strength to bear weight. The contact bond can be changed to an application bond between the primary adhesive and the adherend with the application of additional pressure. Alternatively, after formation of the contact bond, the adhesive article can be removed from the adherend and placed at a second location. In certain implementations, the removal and reformation of a contact bond at a different location may occur up to three times, up to four times, and potentially up to five times without deleteriously affecting the eventual application bond. The engineered adhesive structures thus permit the article to be easily removed from the surface of the adherend, until enough pressure is applied to enable a stronger application bond between the primary adhesive and the surface of the adherend.

To remove the adhesive article from the adherend, at least a portion of the adhesive article is peeled or stretched away from the adherend. In some embodiments, the angle of stretch is 35° or less. In embodiments where a tab is present, the user can grip the tab and use it to release or remove the adhesive article from the adherend.

The adhesive articles can be used in isolation, as one of many articles attached to a surface, or as part of a stack of adhesive articles. In the latter implementation, the resulting construction would include a plurality of adhesive articles disposed in vertical relation to one another.

Uses

The adhesive articles may be used in wet or high humidity environments such as those found in bathrooms. For example, they can be adhered to toilets (e.g., toilet tanks), bathtubs, sinks, and walls. The adhesive article may be used in showers, locker rooms, steam rooms, pools, hot tubs, and kitchens (e.g., kitchen sinks, dishwashers and back splash areas, refrigerators and coolers). The adhesive article may also be used in low temperatures applications including outdoor applications and refrigerators. Useful outdoor applications include bonding articles such as signage to outdoor surfaces such as windows, doors and vehicles.

The adhesive articles may be used to mount various items and objects to surfaces such as painted drywall, plaster, concrete, glass, ceramic, fiberglass, metal or plastic. Items that can be mounted include, but are not limited to, wall hangings, organizers, holders, baskets, containers, decorations (e.g., holiday decorations), calendars, posters, dispensers, wire clips, body side molding on vehicles, carrying handles, signage applications such as road signs, vehicle markings, transportation markings, and reflective sheeting.

The adhesive articles may be used to mount items and materials, such as anti-slip mats or anti-fatigue mats, to a floor surface or the bottom of a tub or shower, or to secure items, such as area rugs, to a floor. The adhesive article can be used in various joining and assembling applications including such as adhering at least two containers (e.g., boxes) for later separation. The adhesive article can be used in various cushioning and sound deadening applications such as, for example, cushioning materials for placement beneath objects, sound insulating sheet materials, vibration dampening, and combinations thereof. The adhesive article can be used in various closure applications including container closures (e.g., box closures, closures for food containers, and closures for beverage containers), diaper closures, and surgical drape closures. The adhesive article can be used in various thermal insulation applications. The adhesive article can be used in various sealing applications such as in gaskets for liquids, vapors (e.g., moisture), and dust. The adhesive article can be used in various labels such as removable labels (e.g., notes, price tags, and identification labels on containers), and in signage. The adhesive article can be used in various medical applications (e.g., bandages, wound care, and medical device labeling such as in a hospital setting). The adhesive article can be used in various fastening applications such as fastening one object (e.g., a vase or other fragile object) to another object (e.g., a table or a book shelf). The adhesive article can be used in various securing applications such as fastening one or more components of a locking mechanism to a substrate (e.g., a child safety lock can be adhered to a cabinet or cupboard). The adhesive article can be used in various tamper indicating applications (e.g., tamper indicating articles). The adhesive article can also be incorporated in a variety of other constructions including, but not limited to, abrasive articles (e.g., for sanding), articles for sanding and polishing applications (e.g., buffing pads, disc pads, hand pads, and polishing pads), pavement marking articles, carpeting (e.g., backing for carpeting), and electronic devices (e.g., securing a battery within a housing in a cell phone or PDA (personal digital assistant) to prevent unwanted movement).

The adhesive article (i.e., those in adhesive tapes or single article) can be provided in any useful form including, e.g., tape, strip, sheet (e.g., perforated sheet), label, roll, web, disc, and kit (e.g., an object for mounting and the adhesive tape used to mount the object). Likewise, multiple adhesive articles can be provided in any suitable form including, e.g., tape, strip, sheet (e.g., perforated sheet), label, roll, web, disc, kit, stack, tablet, and combinations thereof in any suitable package including, for example, dispenser, bag, box, and carton.

The adhesive articles can also be used to affix a substrate, such as an optical lens or cover, to an optical display device, such as a cellular telephone or portable music player (e.g., MP3 players). In such end use applications, it can be desirable that the adhesive article be optically clear.

In some embodiments, the surface to which the adherend is adhered is at least one of drywall, glass, tile, paint, veneer, wood, or other common household surfaces. In some embodiments, the surface is painted. In some embodiments, the surface is painted with a low or no VOC paint.

The following examples describe some exemplary constructions and methods of constructing various embodiments within the scope of the present application. The following examples are intended to be illustrative, but the particular materials and amounts thereof recited in these examples, as well as other conditions and details, should not be construed to unduly limit this disclosure.

### EXAMPLES

Materials

TABLE 1
Materials used for preparation of Secondary Adhesive Layers 2A-2E

| Acronym | Description | Supplier |
|---|---|---|
| 2-EHA | 2-Ethylhexyl acrylate, a monomer | Sigma-Aldrich (St. Louis, |
| | | MO, USA) |
| IBOA | Isobornyl acrylate, a monomer | Sigma-Aldrich (St. Louis, |
| | | MO, USA) |
| Acm | Acrylamide, a monomer | Zibo Xinye Chemical Co., |
| | | LTD (Zibo City, Shandong |
| | | Province, China) |
| AeBP | Acryloylethoxy benzophenone, | Prepared using a method |
| | a copolymerizable monomer containing a | similar to that described in |
| | separately photoreactive group | U.S. Patent 7,838,110 |
| | | B2 (Zhu et al.) |
| TDDM | Tertiary dodecyl mercaptan, a chain | Sigma-Aldrich (St. Louis, |
| | transfer agent | MO, USA) |
| VAZO 52 | (2,2′-azo-bis(2,4-dimethylpentanenitrile), | Dow (Midland, MI, USA) |
| | a thermally activated polymerization | |
| | initiator. | |
| Silica | Aerosil® R 812 S, hydrophobic | Evonik Corporation, |
| | fumed silica | (Parsippany, NJ, USA) |
| MEK | Methyl ethyl ketone, a solvent | Sigma-Aldrich (St. Louis, |
| | | MO, USA) |

Test Methods

Test Substrates

Drywall panels (obtained from Materials Company, Metzger Building, St. Paul, Minn.) were painted with Behr PREMIUM PLUS ULTRA Primer and Paint 2 in 1 Flat Egyptian Nile (“Behr PPU FEN”) obtained from Behr Process Corporation of Santa Ana, Calif., or Sherwin-Williams DURATION, Interior Acrylic Latex Ben Bone White or Beige Paint (“SW Ben Bone”) obtained from the Sherwin-Williams Company of Cleveland, Ohio.

Procedure for painting: a first coat of paint was applied to a panel using a paint roller, followed by air drying for 24 hours at ambient conditions. A second coat of paint was applied and dried at ambient conditions for 7 days and stored at ambient conditions until use.

Glass panels, 2 in×2 in (5.1 cm×5.1 cm) or 6 in×12 in (15.3×30.5 cm), were also used as test substrates (non-tin side) for Package Weight Claim testing and Shear Strength testing.

Package Weight Claim

Package Weight Claim testing was performed using medium size COMMAND utility hooks (Type 17001ES, available from 3M Company, St. Paul, Minn.). Test samples were cut into 5/8 in×2 in (1.6 cm×5.1 cm) strips. The second adhesive side of the test sample (side without secondary adhesive) was first applied to the backplate or mounting base of the COMMAND utility hook. The opposing first adhesive side of the test sample side with secondary adhesive) was then applied to the test substrate. The test samples were subsequently pressed down for 10 seconds by hand with light pressure (approximately less than 5 lbs). The test samples were then pressed down for 30 seconds by hand with firm pressure (approximately greater than 15 lbs) to assure the proper wet-out of the adhesive to the substrate. The samples were mounted in a vertical position and allowed to dwell on the test substrate for 60 minutes at ambient conditions (between 69-72° F. (21-22° C.) and 10-40% relative humidity, depending on the time of year) before attaching a load to the test sample (3, 6, or 9 lb weights). Samples were hung until failure or until 30 days had elapsed. Failure was indicated when it was observed that hook article completely fell off the test substrate (the adhesive no longer adhered to the test substrate surface). The Package Weight Claim data in the Tables is provided as Weight Holding Power (days). The data are an average of 3 tests.

Shear Strength

Shear strength was determined according to the ASTM D3654-06 (2011) method. A 0.5 in×0.5 in (1.3 cm×1.3 cm) square piece the test sample was applied to the test substrate using the first adhesive side of the test sample (ink-passivated or structured adhesive side). A 5/8 in×3 in (1.6 cm×7.6 cm) strip of metalized PET film was then attached to the opposing second adhesive side of the test sample (not ink passivated or structured adhesive side). The metalized PET was folded back onto itself and stapled to provide a means to hang a hanger for attaching a weight. A 15 lb (6.8 kg) hand held roller was passed over the length of the sample two times at a rate of about 12 in/min (30.48 cm/min). The samples were mounted in a vertical position and allowed to dwell on the test substrate for 60 minutes at controlled temperature and humidity conditions of 72° F. (22° C.) and 50% relative humidity before attaching a 1000 gram weight. Samples were hung until failure or until 25,000 minutes had elapsed (note that 10,000 minutes is the ASTM time limit). Failure was indicated when it was observed that test sample completely fell off the test substrate. The Shear Strength in the Tables are an average of 3 tests.

Repositionability

A test method for quantifying repositionability and subsequent holding power was performed using medium size Command™ utility hooks (type 17001ES, available from 3M Company, St. Paul, Minn.). Samples were tested on drywall panels painted with Sherwin-Williams DURATION®, Interior Acrylic Latex Ben Bone as described above. Medium production strips (5/8 in×2 in (1.6 cm×5.1 cm)) were applied to the micro-structured liner with the secondary adhesive applied. The strips were rolled down with a 15 lb roller 2 times before the strip was pulled off the micro-structured liner.

The second adhesive side of the test sample (i.e., the side lacking engineered elements) was first applied to the backplate or mounting base of the COMMAND utility hook. The opposing first adhesive side of the test sample (i.e., the side including engineered elements) was then lightly applied to the test substrate. A load was then applied for 10 seconds to the backplate or mounting base of the test sample to simulate a moderate repositioning force (6 lbs). A hook was then attached to the backplate and the sample was mounted vertically with a 1 lb weight hung on the hook for 7 minutes. The hook and adhesive construction was then removed and lightly reapplied by hand to a separate section of the adherend. The hook was then removed and the 6 lb force was reapplied for 10 seconds. This process was repeated 3 times for a total of 20 minutes hanging a 1 lb weight with moderate repositioning force. Upon the 3rd reposition, a 10 lb load was applied for 30 seconds to the backplate or mounting base of the test sample to assure proper wet-out of the adhesive to the substrate (10 lbs). The samples were mounted in a vertical position at controlled temperature and humidity conditions of 72° F. (22° C.) and 50% relative humidity before attaching a load (3 lbs) to the test sample. Samples were hung until failure or until 30 days had elapsed. Failure was indicated either when damage occurred during the act of repositioning or when it was observed that the hook article completely fell off the test substrate (the adhesive no longer adhered to the test substrate surface). The data are an average of 3 tests.

Gel Permeation Chromatography (GPC)

The molecular weight distribution of the compounds was characterized using conventional gel permeation chromatography (GPC). The GPC instrumentation, which was obtained from Waters Corporation (Milford, Mass., USA), included a high pressure liquid chromatography pump (Model 1515HPLC), an auto-sampler (Model 717), a UV detector (Model 2487), and a refractive index detector (Model 2410). The chromatograph was equipped with two 5 micron PLgel MIXED-D columns, which are available from Varian Inc. (Palo Alto, Calif., USA). Samples of polymeric solutions were prepared by dissolving polymer or dried polymer materials in tetrahydrofuran at a concentration of 0.5 percent (weight/volume) and filtering through a 0.2 micron polytetrafluoroethylene filter that is available from VWR International (West Chester, Pa., USA). The resulting samples were injected into the GPC and eluted at a rate of 1 milliliter per minute through the columns maintained at 35° C. The system was calibrated with polystyrene standards using a linear least square fit analysis to establish a calibration curve. The weight average molecular weight (Mw) and the polydispersity index (weight average molecular weight divided by number average molecular weight) were calculated for each sample against this standard calibration curve.

Dynamic Mechanical Analysis (DMA)

Samples were analyzed by Dynamic Mechanical Analysis (DMA) using a DHR-3 parallel plate rheometer (TA Instruments, New Castle, Del., USA) to characterize the physical properties of each sample as a function of temperature. Rheology samples were extruded into an adhesive film approximately 1 mm thick between silicone coated release liners. After cooling back to room temperature, films were then punched out with an 8 mm circular die, removed from the release liner, centered between 8 mm diameter parallel plates of the rheometer, and compressed until the edges of the sample were uniform with the edges of the top and bottom plates.

Samples were run an under axial force control of 25 grams with a sensitivity of +/−30 grams and conditioned at the start temperature of 860° C. for 6120 seconds prior to starting the test. The temperature was then ramped down from 680° C. to 220-40° C. at 3° C./min while the parallel plates were oscillated at an angular frequency of 1 hertz and a constant strain of 15 percent.

Samples were maintained at 1 percent strain until the oscillatory stress exceeded 10,000 Pa, at which point the test was automatically switched from constant strain to a constant stress of 10,000 Pa for the remainder of the temperature ramp. A step termination condition was enabled to stop the low temperature ramp if the storage modulus (G′) exceeded 1×10⁸ Pa to prevent delamination of the adhesive sample from the fixtures.

While many physical parameters of the material are recorded during the temperature ramp, shear storage modulus (G′), shear loss modulus (G″), and tan delta are of primary importance in the characterization of the copolymers of this invention.

The glass transition temperature, Tg, of the adhesive hard segment can be measured by first determining its storage (G′) and loss shear moduli (G″). The ratio of G″/G′, a unit less parameter typically denoted “tan delta”, is plotted versus temperature. The maximum point (point where the slope is zero) in the transition region between the rubbery region and the viscous region of the tan delta curve, if well defined, determines the Tg of the adhesive hard segment at that particular frequency.

### Examples 1-9

Layer 1 (Primary Adhesive) and Layer 2 (Secondary Adhesive)

Medium size General Purpose Command™ strips (obtained from 3M Company St. Paul, Minn., USA) were used to prepare the adhesive articles of Examples 1-9, with one side of the strip providing primary adhesive Layer 1. The standard Command™ strips comprise a composite film-foam-film backing (31 mil 6 lb. foam with 1.8 mil polyethylene film on both sides of the foam) and a rubber based pressure sensitive adhesive coated onto both sides of the backing. The pressure sensitive adhesive is like the stretch release adhesive composition E-27 in PCT Publication No. WO 2015/195602 (Purgett et al.) and the thickness of the adhesive is approximately 2.75±0.2 mils. The pressure sensitive adhesives used for secondary adhesive Layer 2 are described in detail below (Adhesive solutions 2A-2E).

Layer 3 (Release Liner)

50 um Square/90 um Pitch (˜30% Area Coverage) Release Liner:

A release liner was created with an array of square wells. The walls of the wells were sloped such that the base of the well has a characteristic width smaller than the opening at the top of the well. The width of the wells at their base is approximately 50 um and the center-center spacing of the bottom of the wells is approximately 90 um (leading to the base of the wells having an area coverage of approximately 30%). The depth of the wells is approximately 30 um. The release liner can be made as described in U.S. Pat. No. 5,296,277 or 5,897,930 (both to Wilson et al.), which describe thermal embossing of polyethylene-coated kraft paper that has been release treated with a silicone.

75 um Square/235 um Pitch (˜10% Area Coverage) Release Liner:

A release liner was created with an array of square wells. The walls of the wells are sloped such that the base of the wells have a characteristic width smaller than the openings at the top of the well. The width of the wells at their base is approximately 75 um and the center-center spacing of the bottom of the wells was approximately 235 um (leading to the base of the wells having an area coverage of approximately 10%). The depth of the wells is approximately 90 um. The release liner can be made as described in U.S. Pat. No. 5,296,277 or 5,897,930 (both to Wilson et al.), which describe thermal embossing of polyethylene-coated kraft paper that has been release treated with a silicone.

Preparation of Adhesives Solutions 2A-2B

A general purpose Command™ strip rubber based adhesive like that described for Layer 1 above (at 43% solids in toluene) was used for primary adhesive 2A. Adhesive solution 2B was prepared by adding 4.3 g Silica to 50 g to the standard Command™ adhesive used for primary adhesive 2A. Table 2 below details the formulations for adhesive solutions 2A and 2B.

TABLE 2
Formulations for Adhesive Solutions 2A-2B

| | Command™ | Silica |
|---|---|---|
| | adhesive | weight |
| Adhesive | weight | fraction |
| Sample | fraction (wf) | (wf) |
| 2A | 100 | 0 |
| 2B | 80 | 20 |

Preparation of Adhesive Solutions 2C-2E

Adhesive solution 2C was prepared by adding 25.5 grams 2EHA, 22.5 grams IBOA, 2.0 grams ACM, 0.3 grams of AEBP 50 wt-% solution in ethyl acetate, 0.70 grams TDDM 10 wt-% solution in ethyl acetate, 1.00 grams VAZO 52 10 wt % solution in ethyl acetate and 31.9 grams ethyl acetate were added to an 8 oz (236.6 mL) amber glass bottle. The contents were mixed and bubbled with nitrogen for 2 minutes before being sealed and placed in a Laundrometer rotating water bath (SDL Atlas, Rock Hill, S.C., USA) for 24 hours at 140° F. (60° C.). The sample was analyzed using GPC to determine a Mw of 266 kilodalton and a polydispersity index of 3.5. Adhesive solutions 2D and 2E were prepared in a similar manner to 2C except with the modifications shown in Table 3 below. Table 3 summarizes the compositions used to form the meth(acrylate) copolymer. The amount of crosslinker, and the amount of VAZO 52 are pph (parts per hundred—amount added based on 100 grams of meth(acrylate) copolymer). The weight average molecular weight, polydispersity index, and glass transition temperature for adhesive 2C-2E are shown in Table 4 below.

TABLE 3
Formulations tor Adhesive Solutions 2C-2E

| | Mass (g) | | | | | | |
|---|---|---|---|---|---|---|---|
| | | | | 50 wt % | PPh | | |
| Adhesive | | | | AEBP | VAZO | | EtAC |
| Sample | 2EHA | IBOA | ACM | in EtAc | 52 | TDDM | Mass(g) |
| 2C | 25.5 | 22.5 | 2.0 | 0.3 | 0.1 | 0.07 | 33.3 |
| 2D | 25.0 | 22.5 | 2.5 | 0.3 | 0.1 | 0.07 | 33.3 |
| 2E | 24.5 | 22.5 | 3.0 | 0.3 | 0.1 | 0.07 | 33.3 |

TABLE 4
Mw, PDI, and Tg for Adhesive Solutions 2C-2E

| Adhesive | Mw | | DMA |
|---|---|---|---|
| Sample | (kDa) | PDI | Tg (° C.) |
| 2C | 266 | 3.5 | 21 |
| 2D | 273 | 3.4 | 29 |
| 2E | 256 | 3.2 | 32 |

Preparation of Adhesive Coated Release Liners and Adhesive Strip Articles

The adhesive solutions for 2A and 2B, prepared as described above, were diluted to 10 wt-% solids using toluene. The solutions were then coated onto the release treated side of Layer 3 (release liner), prepared as described above, using a #10 Mayer rod. The coated release liners were dried at 158° F. (70° C.) for at least 20 minutes. Adhesive solutions 2C-2E were also coated in this manner except diluted with methyl ethyl ketone instead. To prepare the adhesive strip articles the adhesive coated release liners were laminated (adhesive side down) to a standard Command™ strip, as depicted in FIG. 4. The adhesive coated release liner constructions for Examples 1-9 are provided in Table 5. The adhesive articles were tested for Package Weight Claim, Shear Strength and Repositionability as described above. The release liners were removed from the adhesive article as needed prior to testing. A standard Command™ strip was tested as a Control sample for comparison. Test results are provided in Tables 6-8.

TABLE 5
Adhesive Coated Release Liner Constructions

| | Primary | Secondary | Surface Area of |
|---|---|---|---|
| Example | Adhesive | Adhesive | Release Liner (%) |
| Control | Command™ | None (Control) | N/A |
| 1 | Command™ | 2B | 10% |
| 2 | Command™ | 2B | 30% |
| 3 | Command™ | 2A | 30% |
| 4 | Command™ | 2C | 10% |
| 5 | Command™ | 2D | 10% |
| 6 | Command™ | 2E | 10% |
| 7 | Command™ | 2C | 30% |
| 8 | Command™ | 2D | 30% |
| 9 | Command™ | 2E | 30% |

TABLE 6
Package Weight Claim Test Results

| | | Weight | Weight Holding |
|---|---|---|---|
| Example | Substrate | (lbs) | Power (days) |
| Control | Glass | 3 | 30+ |
| Control | Behr PPU FEN | 3 | 30+ |
| 1 | Glass | 3 | 30+ |
| 1 | Behr PPU FEN | 3 | 30+ |
| 2 | Glass | 3 | 30+ |
| 2 | Behr PPU FEN | 3 | 30+ |
| 3 | Glass | 3 | Did not test |
| 3 | Behr PPU FEN | 3 | Did not test |
| 4 | Glass | 3 | 30+ |
| 4 | Behr PPU FEN | 3 | 15 |
| 5 | Glass | 3 | 30+ |
| 5 | Behr PPU FEN | 3 | 30+ |
| 6 | Glass | 3 | 30+ |
| 6 | Behr PPU FEN | 3 | 22 |
| 7 | Glass | 3 | 30+ |
| 7 | Behr PPU FEN | 3 | 6 |
| 8 | Glass | 3 | 30+ |
| 8 | Behr PPU FEN | 3 | 12 |
| 9 | Glass | 3 | 30+ |
| 9 | Behr PPU FEN | 3 | 22 |

TABLE 7
Shear Strength Test Results

| | | | Shear |
|---|---|---|---|
| | | Weight | Strength |
| Example | Substrate | (lbs) | (minutes) |
| Control | Glass | 3 | >25,000 |
| Control | Behr PPU FEN | 3 | >25,000 |
| 1 | Glass | 3 | >25,000 |
| 1 | Behr PPU FEN | 3 | >25,000 |
| 2 | Glass | 3 | >30,000 |
| 2 | Behr PPU FEN | 3 | 19,127 |
| 3 | Glass | 3 | Did not test |
| 3 | Behr PPU FEN | 3 | Did not test |
| 4 | Glass | 3 | 1795 |
| 4 | Behr PPU FEN | 3 | 2 |
| 5 | Glass | 3 | 831 |
| 5 | Behr PPU FEN | 3 | 1 |
| 6 | Glass | 3 | 256 |
| 6 | Behr PPU FEN | 3 | 16 |
| 7 | Glass | 3 | 7572 |
| 7 | Behr PPU FEN | 3 | 4 |
| 8 | Glass | 3 | 17526 |
| 8 | Behr PPU FEN | 3 | 1 |
| 9 | Glass | 3 | 574 |
| 9 | Behr PPU FEN | 3 | 1 |

TABLE 8
Repositionability Test Results

| | | | | | Average days |
|---|---|---|---|---|---|
| | | 1^{st} | 2^{nd} | 3^{rd} | hung (final |
| Example | Substrate | Reposition 1 | Reposition 2 | Reposition 3 | weight) |
| Control | SW BenBone | Significant | N/A | N/A | N/A |
| | | damage when | | | |
| | | attempting to | | | |
| | | reposition | | | |
| 1 | SW BenBone | Did not test | N/A | N/A | N/A |
| 2 | SW BenBone | Pass | Pass | Pass | 24 |
| | | (no damage) | (no damage) | (no damage) | |
| 3 | SW BenBone | Pass | 1/3 rep | 1/3 rep | 30+ |
| | | (no damage) | exhibited | exhibited | |
| | | | small damage | small damage | |
| 4 | SW BenBone | Did not test | N/A | N/A | N/A |
| 5 | SW BenBone | Did not test | N/A | N/A | N/A |
| 6 | SW BenBone | Did not test | N/A | N/A | N/A |
| 7 | SW BenBone | Pass | Pass | Pass | <1 |
| | | (no damage) | (no damage) | (no damage) | |
| 8 | SW BenBone | 1/3 rep fell 4 | Pass | Pass | <1 |
| | | mins after 1^{st} | (no damage) | (no damage) | |
| | | reposition | | | |
| 9 | SW BenBone | 1/3 rep fell 2 | Pass | Pass | <1 |
| | | mins after 1^{st} | (no damage) | (no damage) | |
| | | reposition | | | |
| | | 3/3 reps | | | |
| | | exhibited | | | |
| | | blistering after | | | |
| | | 1^{st} reposition | | | |

The patents, patent documents, and patent applications cited herein are incorporated by reference in their entirety as if each were individually incorporated by reference. It will be apparent to those of ordinary skill in the art that various changes and modifications may be made without deviating from the inventing concepts set from above. Thus, the scope of the present disclosure should not be limited to the structures described herein. Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

1. A repositionable, stretch releasable adhesive article comprising;
a first adhesive layer defining a first outer surface; and a second adhesive layer on or partially embedded in the first outer surface, wherein the article has a tensile strength at break sufficiently high so that the article will not rupture prior to being stretched and removed from an adherend at an angle of 35° or less, wherein the second adhesive layer includes a plurality of engineered adhesive elements.

2. The adhesive article of claim 1, wherein the second adhesive layer includes an arranged pattern or distribution of adhesive elements.

3. The adhesive article of claim 2, wherein the adhesive elements comprise discrete islands of adhesive material.

4. The adhesive article of claim 2, wherein the adhesive elements comprise rails extending over at least a portion of the first surface.

5. The adhesive article of claim 1, wherein the second adhesive layer comprises between about 3% and about 40% percent of a total surface contact area of the first adhesive layer.

6. The adhesive article of claim 5, wherein the second adhesive layer comprises between about 10% and about 30% percent of a total surface contact area of the first adhesive layer.

7. The adhesive article of wherein the second adhesive layer forms an initial contact bond upon contact with a substrate, and wherein the first adhesive layer forms an application bond upon contact with a substrate, and wherein the contact bond has a reduced peel adhesion to the substrate as compared to the application bond.

8. The adhesive article of claim 7, wherein the article holds a weight of 1 pound for at least 10 minutes upon formation of the contact bond.

9. The adhesive article of claim 6, wherein the article is repositionable after formation of the contact bond.

10. The adhesive article of claim 1, wherein the second adhesive layer has a reduction in adhesive properties (peel adhesion or tack) as compared to the primary adhesive layer of at least about 25% after a 1 week dwell time as measured by ASTM D3330/3330M-04 (for peel adhesion) or ASTM D2979-01 (2009) (probe tack).

11. The adhesive article of claim 1, wherein the adhesive article exhibits a shear strength of greater than 25,000 minutes as measured according to ASTM D3654-06 (2011) after formation of an application bond between the adherend and the first adhesive layer.

12. The adhesive article of claim 1, wherein the either or both the first adhesive layer and second adhesive layer includes natural rubber, synthetic rubber, silicone, (meth)acrylate, hydrocarbon block copolymers, polyurethane, silicone block copolymers, or a combination thereof.

13. The adhesive article of claim 12, wherein each of the first and second adhesive layers include one or more hydrocarbon block copolymers and a phenolic tackifier.

14. The adhesive of claim 13, wherein the second adhesive layer includes a fumed silica filler.

15. The adhesive article of claim 1, and further comprising a plurality of channels on the first outer surface, and wherein the channels define exit pathways that provide a fluid egress.

16. The adhesive article of claim 1, wherein the article is at least one of repositionable and repositionable holding

17. A method for securing a stretch-release adhesive article to a mounting surface, the method comprising:
providing the article including a first adhesive layer and a first outer surface; and a distribution of adhesive elements on or partially embedded in the first outer surface, wherein the article has a tensile strength at break sufficiently high so that the article will not rupture prior to being stretched and removed from an adherend at an angle of 35° or less;
adhering the article to the mounting surface at a first location on the mounting surface;
moving the article to a second location on the mounting surface remote from the first location;
and adhering the article to the mounting surface at the second location.

18. The method of claim 17, wherein moving the article to a second location comprises removing the article from the surface without stretching of the article or damage to the mounting surface.

19. The method of claim 17, wherein adhering the article to the mounting surface at the first location comprises forming a contact bond between the second adhesive layer and the mounting surface, and wherein adhering the article to the mounting surface at the second location comprises forming an application bond between the first adhesive layer and the mounting surface,

20. The method of claim 19, wherein the article holds a weight of 1 pound for at least 10 minutes upon formation of the contact bond.
